(19) United States
(12) Patent Application Publication
(10) Pub. No.: US 2018/0186180 A1
(43) Pub. Date: Jul. 5, 2018

(54) REMOVABLY ATTACHABLE, DETACHABLE WHEEL

(71) Applicant: Paul V. Zoubarev, Vernon Hills, IL (US)

(72) Inventor: Paul V. Zoubarev, Vernon Hills, IL (US)

(21) Appl. No.: 15/854,085

(22) Filed: Dec. 26, 2017

Related U.S. Application Data
(60) Provisional application No. 62/440,760, filed on Dec. 30, 2016.
(60) Provisional application No. 62/447,552, filed on Jan. 18, 2017.

(51) Int. Cl. B60B 19/12

(52) U.S. Cl. CPC B60B 19/12; B62B 2301/05; B62B 3/002; B60B 2900/121; B60B 2900/541; B60B 2200/43

(57) ABSTRACT

The invention provides a wheel having a disk-shaped substrate having a first surface, a second surface and a periphery; and a radially extending channel formed within the substrate, wherein the channel has a closed end adapted to encircle an axle and an open end which terminates at the periphery such that the channel extends from the first surface to the second surface. Also provided is a method for installing and uninstalling wheels having the steps of supplying a wheel having a reversibly deformable radially and transversely extending channel having a first width, whereby the channel is adapted to frictionally and slidably receive an axle, urging the axle into the channel and toward the center of the wheel, whereby the channel reversibly expands to a second width to accommodate the axle; and allowing the axle to reside at the center of the wheel while the channel reverts to the first width.

### PRIORITY

This utility patent application claims the benefits of U.S. Provisional Application No. 62/440,760 filed on Dec. 30, 2016 and of U.S. Provisional Application No. 62/447,552 filed on Jan. 18, 2017, the entirety of which are incorporated herein by reference.

### BACKGROUND OF THE INVENTION

### 1. Field of the Invention

This invention relates to wheels and more specifically, this invention relates to snap on, snap off wheels for use in transporting light and medium duty containers.

### 2. Background of the Invention

Transport of bulky items (such as tennis balls, sundry items, light weight extruded parts) on treated surfaces (such as epoxy surfaces, rubberized surfaces, finished wood floors, tile floors, etc.) is a common occurrence. Such transport requires care so as to minimize transport effort, while simultaneously protecting the surfaces. These two requirements mandate low friction interaction between the wheel and the surfaces.

Low friction, non-marking wheels are necessarily wide and smooth. Further, inasmuch as the wheels are typically mated to static wire frames serving as axles, the aspect ratio (d₁:d₂, wherein d₁ is the distance from the center of the wheel to its periphery and d₂ is the footprint width of the wheel) is typically low, e.g., less than 50 percent. This wide foot print causes the wheel to wear out quickly, and often unevenly.

FIGS. 1A and 1B show diagrams of a typical wheel at the beginning (FIG. 1A) and at the end (FIG. 1B) of its useful life. The wheel 1 is depicted as longer than wider. The wheel is adapted to be received by a wire support 2 such that the support 2 is coaxial with the wheel and serves as the axle about which the wheel 1 rotates.

FIG. 1B depicts the wheel at the end of use. While FIG. 1 A depicts the wheel as generally cylindrical in shape, FIG. 1B shows the wheel worn down to a frustoconical shape. Specifically, distal portions 3 of the worn wheel are shown having a cross section that is less than the cross section of medially situated portions 4 of the worn wheel. In this configuration, the distal portions 3 of the wheel are those portions residing near the end of the axle.

Once the wheels are worn to this degree, undue stress is placed on the wire frame 2 of the vehicle. This causes undue wear to the frame, which is potentially more problematic than wheel wear. Also, the wheel does not rotate as efficiently along a straight line. Finally, the wheel fails. This often results in the entire system (wheel and basket) having to be replaced.

A need exists in the art for a wheel system that minimizes friction with whatever surface the surface rolls upon. The system should allow for reversible mounting and removal of wheels to the conveyance utilizing the wheels for transport.

### SUMMARY OF INVENTION

An object of the invention is to provide wheels to facilitate transport of bulk items that overcomes many of the drawbacks of the prior art.

Another object of the invention is to provide a wheel to transport baskets containing bulky items. A feature of the invention is that the wheels are reversibly mounted, dismounted from the basket. An advantage of the invention is that no hand tools are necessary for mounting or dismounting. Another advantage is that the wheels are adapted to receive a myriad of axle cross section diameters. Still another advantage is that different wheels can be mounted on the same vehicle, depending on the surface over which the carrier is rolling. For example, wheels comprising soft substrate such as rubber, neoprene rubber, nylon, urethane, thermoplastic rubber (TPR) or other soft tread materials may be used on hard floors (i.e., wood, tile, concrete, etc), but latter swapped out for low friction wheel constituents (such as mold on polyurethane, polyolefins, hard plastic, wood, metal, fiber glass), when the carrier is being used on carpet, grass or other soft surfaces.

Briefly, the invention provides a wheel comprising a generally disk-shaped substrate having a first surface, a second surface and a periphery; and a radially extending channel formed within the substrate, wherein the channel has a first closed end adapted to encircle an axle and a second open end which terminates at the periphery such that the channel transversely extends from the first surface to the second surface.

Also provided is a method for installing and uninstalling wheels, the method comprising supplying a wheel having a reversibly deformable radially extending and transversely extending channel having a first width, whereby the channel is adapted to frictionally and slidably receive an axle, urging the axle into the channel and toward the center of the wheel, whereby the channel reversibly expands to a second width to accommodate the axle; and allowing the axle to reside at the center of the wheel while the channel reverts the first width.

### BRIEF DESCRIPTION OF DRAWING

The invention together with the above and other objects and advantages will be best understood from the following detailed description of the preferred embodiment of the invention shown in the accompanying drawings, wherein:

FIGS. 1A and 1B depict a prior art wheel shown before extended use in FIG. 1A and after extended use in FIG. 1B

FIG. 2A is a perspective view of a solid core wheel, in accordance with features of the present invention;

FIG. 2B is a plan view of the solid core wheel:

FIG. 2C depicts a solid wheel with an audio signature feature, in accordance with features of the present invention;

FIG. 3A is a perspective view of a wheel, in accordance with features of the present invention;

FIG. 3B is a plan view of the wheel of FIG. 3A;

FIG. 3C is a plan view of a wheel with diamond shaped slots, in accordance with features of the present invention;

FIG. 3D is a view of FIG. 3A taken along line D-D;

FIG. 4 depicts an embodiment of the wheel in use, in accordance with features of the present invention;

FIG. 5A is a plan view of an embodiment of the wheel, in accordance with features of the present invention;

FIG. 5B is a view FIG. 5A taken along line B-B;

FIG. 5C is a view of FIG. 5A taken along line C-C;

FIG. 5D is a perspective view of an embodiment of the wheel, in accordance with features of the present invention;

FIG. 6A is a plan view of a wheel, in accordance with features of the present invention;

FIG. 6B is a view of FIG. 6A taken along line B; and

FIG. 7 is a version of the wheel depicted in FIGS. 6A and 6B installed on a tennis ball caddy, in accordance with features of the present invention.

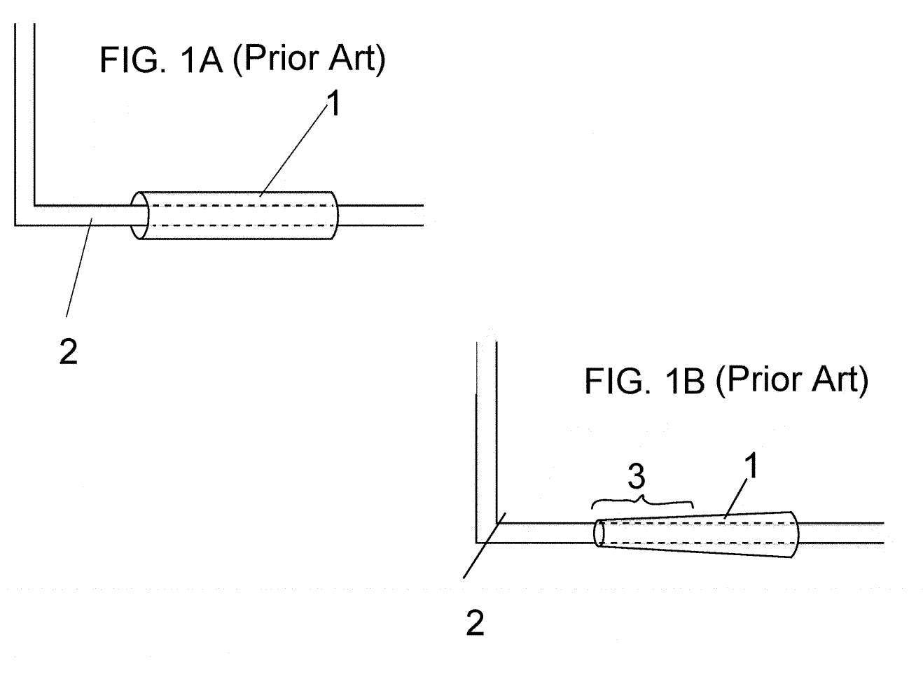

### DETAILED DESCRIPTION OF THE INVENTION

The foregoing summary, as well as the following detailed description of certain embodiments of the present invention, will be better understood when read in conjunction with the appended drawings.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

The following detailed description should be read with reference to the drawings in which similar elements in different drawings are numbered the same. The drawings, which are not necessarily to scale, depict illustrative embodiments and are not intended to limit the scope of the invention.

As used herein, an element or step recited in the singular and preceded with the word “a” or “an” should be understood as not excluding plural said elements or steps, unless such exclusion is explicitly stated. As used in this specification and the appended claims, the term “or” is generally employed in its sense including “and/or” unless the content clearly dictates otherwise.

Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

### Solid Wheel

### Detail

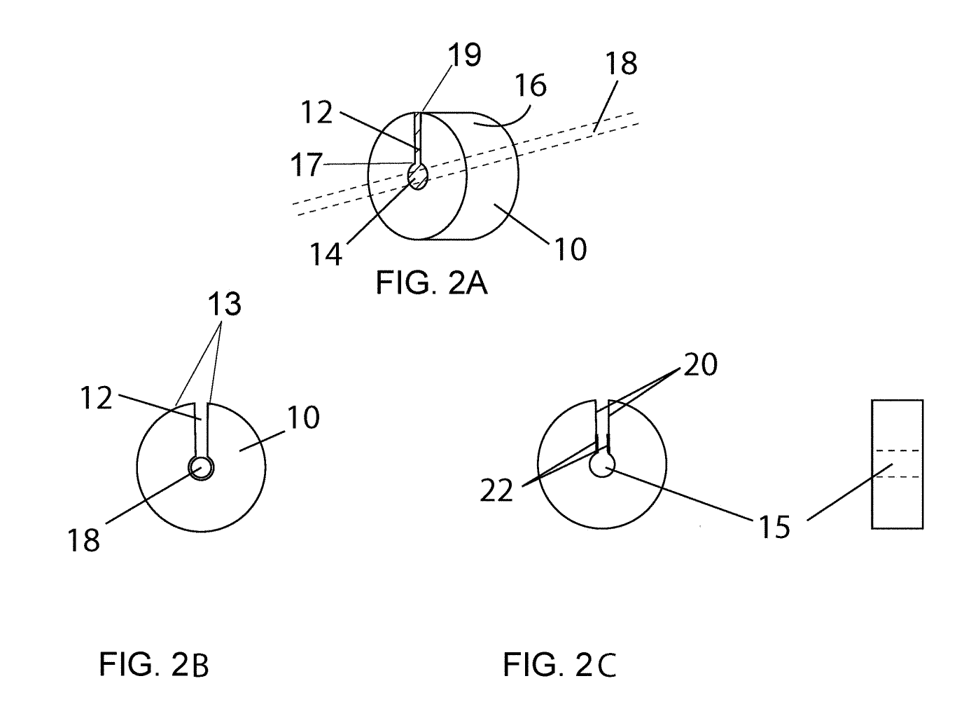

FIG. 2A is a perspective view of a spoke-less version of the invented wheel, the wheel shown as a disk and designated as numeral 10. FIG. 2B is a plan view of the wheel depicted in FIG. 2A.

FIG. 2A is a perspective view showing a solid core wheel 10 but for a radially extending slot 12. The slot 12 originates from the center 14 of the wheel at a first end 17 and terminates at the periphery 16 of the wheel at its distal or second end 19. The slot 12 extends the entire depth of the wheel so as to form a transverse extending channel defining a radius of the wheel. Similarly, the center of the wheel 14 defines a generally circular, transverse extending tunnel 15 adapted to receive an axle 18. Access to this tunnel 15 is thereby conferred at the distal end 17 of the slot 12 forming a mouth 13 of the slot 12, the mouth defined by opposing edges of the periphery 16 of the wheel 10.

The tunnel 15 defines cross section adapted to rotatably communicate with an axle 18 encircled thereby. This communication may be friction free or it may include some friction so as to prevent the cart from inadvertently rolling away. (Alternatively, one or some of the wheels, but not all of the wheels may frictionally engage with the axle.)

An interplay exists between the cross section diameter of the axle and the width of the slot. For example, the cross section diameter of the axle and the width of the slot may be configured to facilitate slidable, yet frictional interaction between the axle and the slot. In this embodiment, and as seen in FIG. 2B, the axle 18 is larger in diameter than the width 12 of the slot, but smaller in diameter than the center aperture 15 of the wheel. This feature allows free rotation of the axle after the wheel is nesting within the center 14 of the wheel, but prevents the axle from migrating back into the slot.

In another alternative configuration (FIG. 2C), distal radially displaced regions 20 of the slot adjacent to its second end may define a width that is similar to the cross section of the axle, while proximal regions 22 of the slot adjacent to its first end may define a width that is fractionally smaller than the cross section of the axle. This two step configuration facilitates easy loading of the wheel onto distal regions of the slot so as to allow for leverage in overcoming the frictional resistance imparted by proximal regions of the slot. Upon overcoming the frictional resistance imparted by the narrowing proximal regions 22 of the slot, an audio signature may be heard wherein the medially facing surface of the aperture 15 slaps against the axle, thereby signifying final nesting of the axle within the tunnel 15 of the wheel. It should be noted that this audio signature feature may be integrally molded with any version of the wheels described herein.

This two step configuration may be effected by converging the sides of the channel as the channel extends toward the center of the wheel. The degree of convergence is suitable to effect frictional engagement of the axle with the proximal or first end of the channel 12. For example, suitable degrees may range from more than 0 degrees to less than 15 degrees.

### Spoked Wheel

### Detail

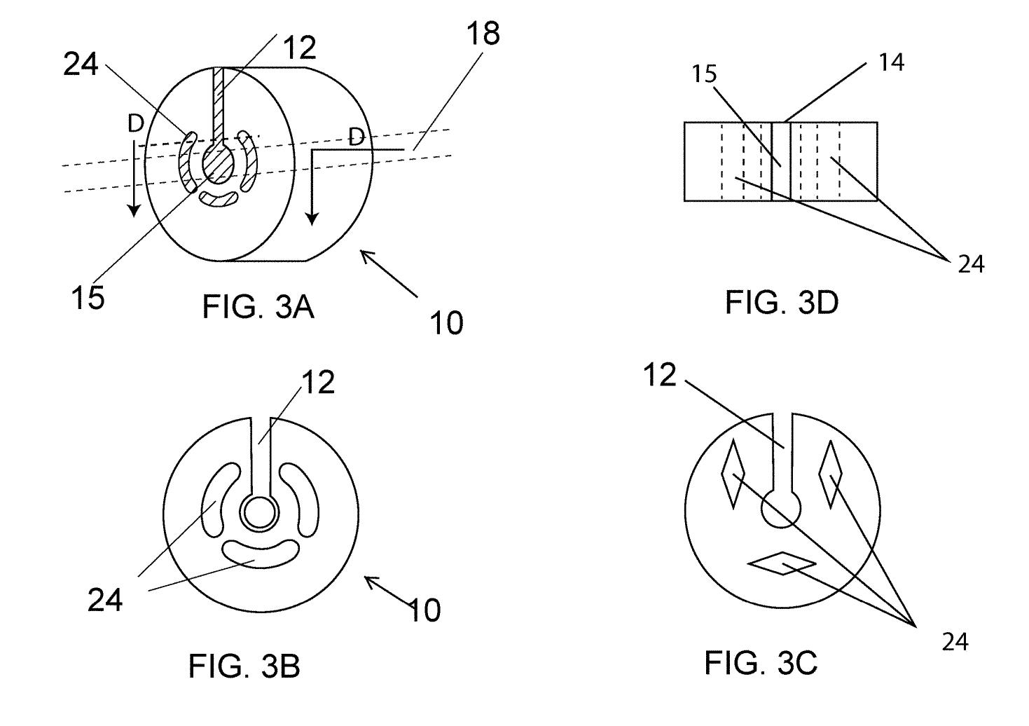

FIGS. 3A-B, and 3D depicts another embodiment of the invented wheel 10. As with the embodiment depicted in FIGS. 2A-C, this embodiment comprises a radially extending channel 12 with a first end originating at the center 14 of the wheel and a second end of the channel terminating at the periphery of the wheel. FIG. 3A is a perspective view while FIG. 3B is an elevation view of this embodiment.

This embodiment features a plurality of cut outs 24 concentrically arranged about the center 14 of the wheel. As depicted in FIG. 3D (which is a view of FIG. 3A taken along line D-D), the cut outs extend transversely through the entire width “W” of the wheel. The cut outs may be arcuate in shape as shown. Alternatively, the cut outs 24 may be shaped as circles, triangles or any other geometric pattern.

The cutouts provide a means for conserving weight. Depending on the number of cut outs 24, compared to a similarly sized wheel depicted in FIGS. 2A-C, an embodiment featured in FIGS. 3A-D provides a weight savings of between about 5 and 20 percent. This results in a cost savings of about 5 to 15 percent.

Either wheel embodiment may be fabricated in a myriad of sizes. For example, suitable dimensions for either wheel would be an outer diameter of 1.25 inches, and inner diameter of the axle aperture 15 of 0.25 inches, and wheel width (i.e. contact patch) dimensions of from 0.5 inches to 0.75 inches to 1 inch.

### Operation Detail

In operation, a user installs the wheel on the axle 18 simply by aligning the channel 12 with the axle 18 and forcing the center of the wheel onto the axle. Conversely, the wheel is removed from the axle by aligning the channel with the axle and pulling the wheel away from the axle, while maintaining that alignment. No tools are required to mount or dismount the wheels from the axle.

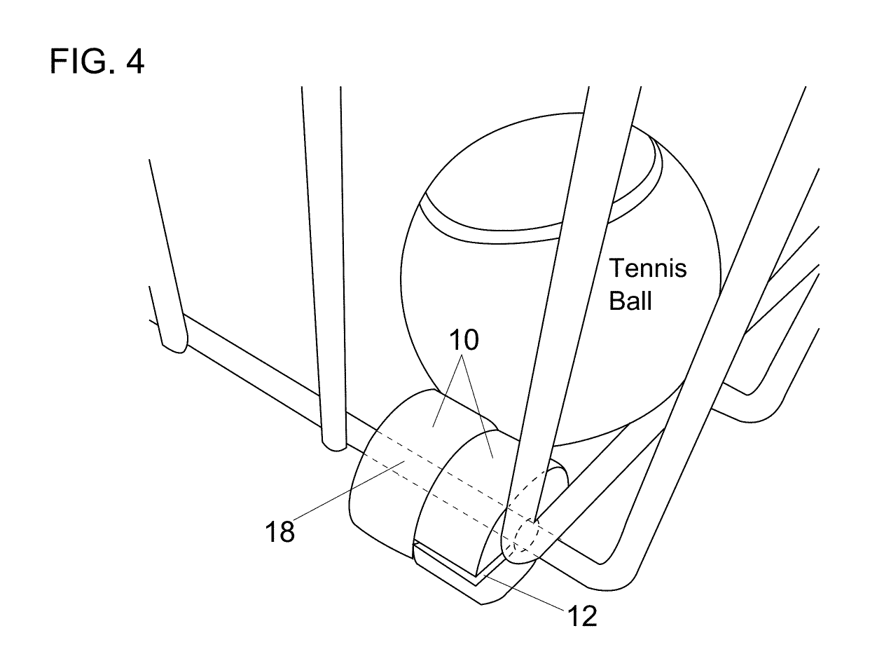

A principle mode of use is where a wheel is mounted to a first end of an axle and a second wheel is mounted to a second end of the axle. However, more than one wheel may be mounted to the same area of an axle, such that the sides of adjacent wheels contact each other, as depicted in FIG. 4. In such instances, when one of the wheels wears out (for example the outermost wheel) that wheel can be replaced while keeping the inwardly positioned wheel(s) in service. That inwardly positioned wheel may be slid along the axle 18 to the original position of the replaced wheel and a fresh wheel then placed in the original position of the inwardly positioned wheel. This feature allows the vehicle to remain in service, while rotating in and out new wheels as they become available. This also provides a means for distributing weight of the vehicle along longitudinally extending portions of the axle 18.

As discussed supra, the invented wheel could be constructed from any rigid, semi-rigid, or flexible material. Suitable rigid material includes commercially available polymers such as ultra high molecular weight (UHMW) Polyetheylene from McMaster-Carr of Elmhurst, Ill. or polyoxymethylene commercially available from DuPont USA (Wilmington, Del.) as Delrin®. Also, in the case of a multiwheel installation whereby adjacent wheels are in close spatial relationship to each other, the exterior of the opposing faces of the adjacent wheels may be treated to either enhance frictional engagement of the wheels to facilitate both wheels turning in unison, or else treated to minimize frictional engagement so as to allow the wheels to turn independently of each other. To enhance friction engagement, the opposing surfaces may be roughened or else treated with an adhesive. To minimize frictional engagement, the opposing surfaces may be sprayed with silicone, oil, or else polished to minimize roughness.

A salient feature of the construction is that it can be integrally molded as one piece, such that no moving parts are present. In this configuration, the single piece would comprise reversibly deformable material so as to confer “give” to the wheel channel 12 as the wheel is being mounted and dismounted from the axle 18. This “giving” feature comprises the channel opening slightly, reminiscent of a pair of jaws, as the wheel is forced over the axle. This “giving” feature allows the wheel to be installed or removed with a force greater than about 1 Newton and less than approximately 100 Newtons (N), and typically between about 10 N and about 80 N, and preferably above 20 N and below about 40N. In light of the foregoing, wheel installation and removal may be effected with one's bare hands with no hardware or specialized tools required.

The embodiment depicted in FIGS. 3A-D featuring the cutouts, may facilitate this jaw opening and closing feature, depending how the cut outs are configured vis-à-vis the transversely extending axle channel 15. For example, and as depicted in FIG. 3C, the cutouts 24 may be arranged so as to allow their surfaces to reversibly collapse within the voids defined by the cutouts when the channel is forced open during axle installation. FIG. 3C features two cut outs flanking and laterally disposed from longitudinally extending sides of the channel 12, and a third cut out underlying the channel and first two cutouts. More or fewer cutouts may be utilized. Generally, the opening of the channel 12 and the cutouts are coplanar.

Alternatively, the wheel may comprise a plurality of parts which can be reversibly assembled and disassembled. For example, the wheel may comprise two halves which can be snap fit in place, or twisted loose in times of replacement or repair. Such assembly, disassembly may occur while the wheel is not yet mounted on the axle, or while the wheel is still mounted to the axle.

In either case, the wheel may be mounted and dismounted without the aid of hand tools, adhesive, solvent or any special skills.

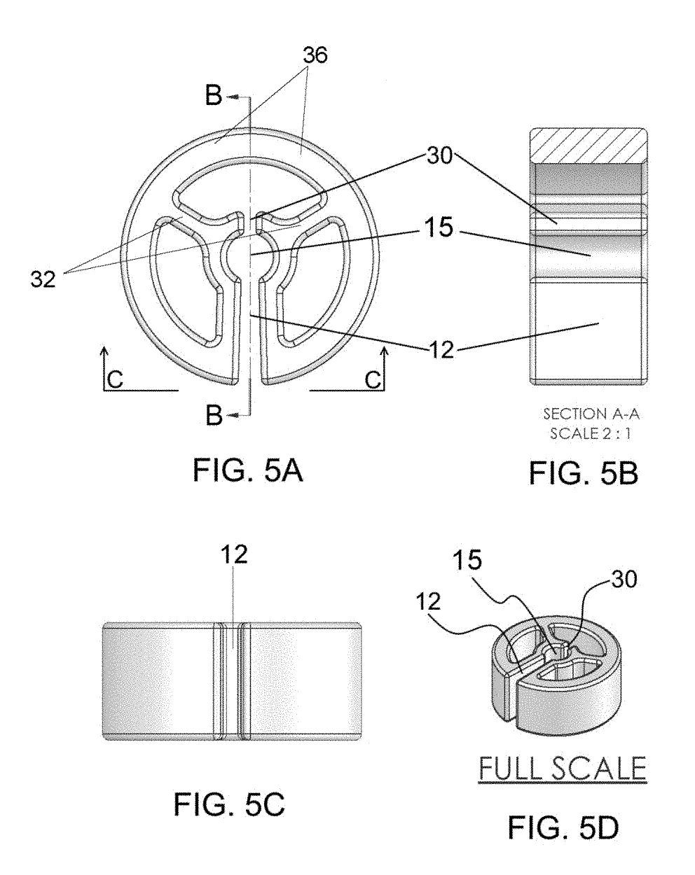

FIGS. 5A-D depict another version of the invented wheel. Like the previous embodiments described supra, this embodiment features a central aperture 15 adapted to receive an axle. However, unlike the previous embodiments, the central aperture 15 of this embodiment also defines a second channel 30 that is diametrically opposed to the axle access channel 12. However, this second channel 30 breaches the periphery of the central aperture 15 only, and not the periphery of the entire wheel. The provision of the second channel 30 is facilitated by the spoke-like configuration depicted in FIGS. 5A-D. As such, the wheel depicted in FIGS. 5A-D features a plurality of spokes 32, at least one spoke, typically 1 to 4 spokes, and preferably 3 spokes. One of the spokes defines the axle channel 12 such that it is adapted to slidably receive a cross section diameter of the axle 18.

Medially situated ends of the spokes 32 form a central hub 34. The center of the hub 34 defines the aperture 15 through which the axle 18 finally nests and extends therethrough. The second channel 30 is formed as a radially extending slot through a portion of the hub 34 such that a first end of the channel breaches the periphery of the aperture 15, and the second end opens into a void formed in the wheel, the void positioned between the hub 34 and a rim 36 of the wheel. Laterally situated ends of the spokes 32 terminate at the rim and may be integrally molded with the rim 34.

The second channel 30 provides a means for prying open or otherwise increasing the width of the first channel 12 during axle mounting and dismounting. This feature eliminates the need for strategically placed arcs or slots in the wheel as discussed supra. This features confers a reversible widening character to the first channel 12. Generally, the second channel 30 extends radially from the central aperture 15 in a direction opposite the direction in which the first channel 12 extends.

The second channel makes it even less of a requirement for a hand tool to facilitate mounting/dismounting of the wheel onto an axle.

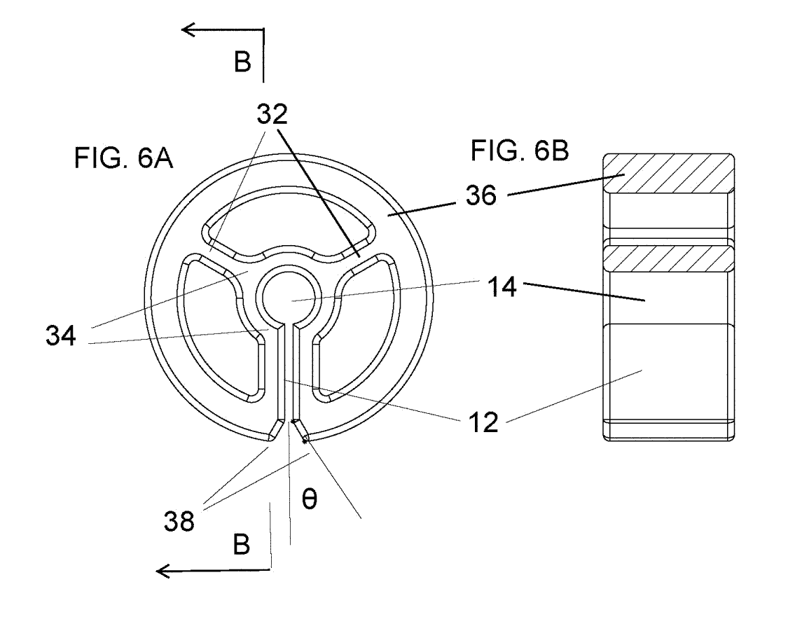

FIGS. 6A-B depict another version of the invented wheel. As with the configuration in FIGS. 5A-D, this version of the wheel comprises a plurality of radially extending spokes 32 with their proximal ends forming a hub 34, and their distal ends terminating at a rim 36.

FIG. 6A is a plan view of the wheel. FIG. 6B is a view of FIG. 6A taken along line B-B. A salient feature of the wheel is that the distal end of the channel 12 terminating at the wheel periphery is in a flared configuration. This flare 38 facilitates easy and rapid feeding of the cross section of the axle 18 into the channel 12.

The flare may be larger than the cross section of the channel so as to form a frusto-conical structure deviating at an angle θ from about 10 to about 30 degrees off the center axis of the channel 12. As such, the entire yaw of the flare may from 20 to 60 degrees. This yaw (essentially a wide mouth) serves as a funnel for easy acquisition of the axle 18.

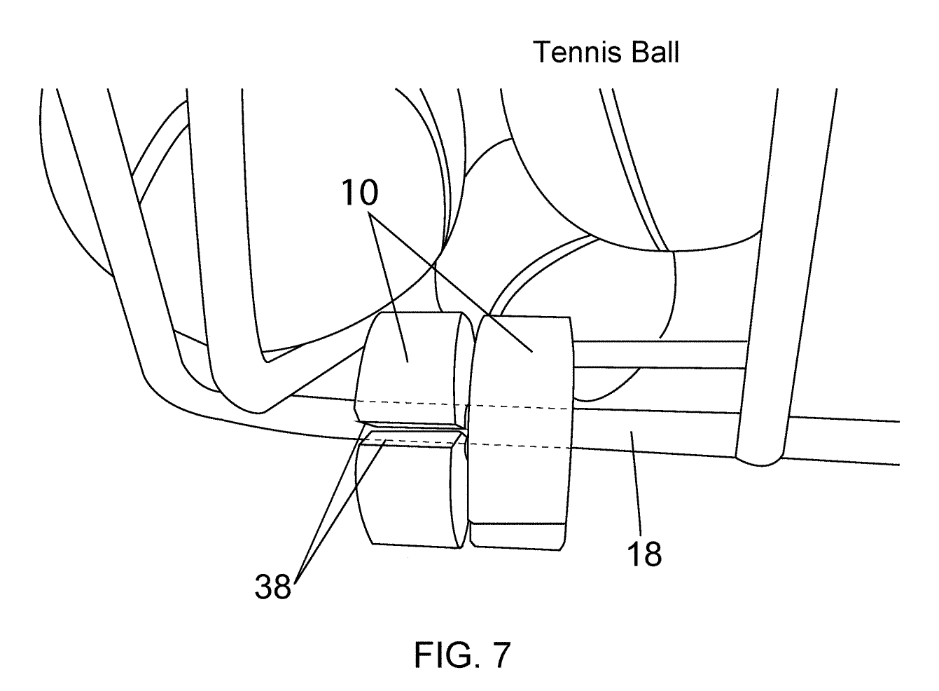

FIG. 7 shows this wheel embodiment mounted on an axle of a tennis ball caddy, the figure depicting a double wheel mounting configuration similar to that shown in FIG. 4.

It is noteworthy that the wheel depicted in FIGS. 6A-B does not contain an opposing channel 30 seen in FIGS. 5A, 5B, and 5D. Surprisingly and unexpectedly, the heretofore described flare 38 facilitates separation of the sides of the channel during axle interaction and therefore eliminates the need for the channel 30.

In operation, the installation and removal of the invented wheels can be achieved without the use of tools, adhesives, or irreversible processes such as brazing or welding. In an embodiment of the wheel as discussed supra, the installer is notified of proper nesting of the wheel around the axle upon hearing a click or other audio signature upon installation. The radially extending slot 12 of the wheel is first aligned orthogonally with the longitudinal axis 18 of the axle. Then, the installer applies a sufficient force (see Newton discussion, supra) by hand to urge the wheel toward the axle until the center aperture 15 encircles the axle such that the axle is seated within the aperture. Certain versions of the invented wheel provide for an audio signature when the axle passes through the slot 12 and is captured within the aperture 15.

Removal of the wheel is a reverse of the above-described installation procedure.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” “more than” and the like include the number recited and refer to ranges which can be subsequently broken down into subranges as discussed above. In the same manner, all ratios disclosed herein also include all subratios falling within the broader ratio.

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

1. A wheel comprising:
a) a generally disk-shaped substrate having a first surface, a second surface and a periphery;
b) a first radially extending channel formed within the substrate, wherein the channel has a first closed end adapted to encircle an axle and a second open end which terminates at the periphery such that the channel transversely extends from the first surface to the second surface.

2. The wheel as recited in claim 1 wherein the first channel further comprises a region spanning its first end and its second end, whereby the region has a width that is less than the cross section of the axle.

3. The wheel as recited in claim 1 wherein the first channel further comprises a region spanning its first end and its second end, whereby the region has a width that is approximately the same as the cross section of the axle.

4. The wheel as recited in claim 1 wherein the wheel comprises a single piece so as to have no moving parts.

5. The wheel as recited in claim 2 wherein the wheel comprises a reversibly deformable material so as to allow it to expand to allow passage of the axle.

6. The wheel as recited in claim 1 wherein the first closed end of the first channel is located at the center of the disk to form a transverse aperture.

7. The wheel as recited in claim 1 wherein the disk is devoid of any openings between its center and its periphery.

8. The wheel as recited in claim 1 wherein regions intermediate the disk's center and periphery define a plurality of apertures.

9. The wheel as recited in claim 8 where the apertures extend through the disk from its first side to its second side.

10. The wheel as recited in claim 8 wherein the apertures are reversibly deformable.

11. The wheel as recited in claim 6 further comprising a second channel formed in a region of the periphery of the transverse aperture, the region diametrically opposed to the first channel.

12. The wheel as recited in claim 1 wherein in the second end of the channel defines an inverse frustoconical surface.

13. A method for installing and uninstalling wheels, the method comprising:
a) supplying a wheel having a reversibly deformable radially extending and transversely extending channel having a first width, whereby the channel extends radially in a first direction and is adapted to frictionally and slidably receive an axle.
b) urging the axle into the channel and toward the center of the wheel, whereby the channel reversibly expands to a second width to accommodate the axle; and
c) allowing the axle to reside at the center of the wheel while the channel reverts to its first width.

14. The method as recited in claim 13 wherein the channel has a first closed end adapted to encircle an axle and a second open end which terminates at a periphery of the wheel such that the channel transversely extends from a first side to a second side of the wheel.

15. The method as recited in claim 13 wherein no tools or adhesives are required to perform the method.

16. The method as recited in claim 14 wherein regions of the wheel intermediate the disk's center and periphery define a plurality of apertures not contiguous with with the void formed by the channel.

17. The method as recited in claim 16 wherein the apertures reversibly deform during installation of the axle.

18. The method as recited in claim 13 wherein the urging step comprises prying apart opposing surfaces of the first channel.

19. The method as recited in claim 18 wherein a second channel extends from the center of the wheel in a second direction opposite the first direction.

20. The method as recited in claim 19 wherein the second channel does not breach the periphery of the wheel.
